(19) United States
(12) Patent Application Publication
(10) Pub. No.: US 2008/0246200 A1
(43) Pub. Date: Oct. 9, 2008

(54) Vibration Isolation System and Method

(75) Inventors: Michael J. Varvoordeldonk, Rosmalen (NL); Henry Stoutjesdijk, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/092,860

(22) PCT Filed: Nov. 2, 2006
(86) PCT No.: PCT/IB06/54066

§ 371 Date: May 7, 2008

Related U.S. Application Data
(60) Provisional application No. 60/734,455, filed on Nov. 8, 2005.

(51) Int. Cl. F16F 7/10; F16F 9/00

(52) U.S. Cl. 267/140.14; 248/550

(57) ABSTRACT

A system and method for isolating a mass from vibration including an actuator 34 operably connected to the mass 32, the actuator 34 being responsive to a combined control signal 46; a position sensor 36 operably connected to measure position of the mass 32, the position sensor 36 generating a position signal 38; a comparator 51 responsive to the position signal 38 and a position setpoint signal 58 to generate a position error signal 50; and a combination controller 40 responsive to the position error signal 50 to generate the combined control signal 46; wherein the combination controller 40 adjusts the combined control signal 46 to change system characteristics when the position error signal 50 is outside an operating range.

This invention relates generally to vibration isolation systems, and more specifically to vibration isolation systems with non-linear control.

Certain sensitive manufacturing processes and instrumentation require isolation of a mass from vibrations in their surroundings. One example of a sensitive manufacturing process is photolithography for producing integrated circuits. The wafer on which the integrated circuits are made is docked on a table, which is sensitive to floor vibrations. Any vibration affects the accuracy of the photolithography and reduces the quality of the integrated circuits. One example of sensitive instrumentation is seismic instrumentation, such as geophones. In seismic instrumentation, a mass is held stationary and its velocity measured relative to its surroundings to measure seismic activity. The mass must be free-floating to detect floor vibrations. Another example of use in sensitive instrumentation is use of a mass as the reference mass in a payload isolation system for active vibration isolation comprising an inertial reference mass, as described in WIPO International Publication No. WO 2005/024266 A1, to Vervoordeldonk, et al., entitled Actuator Arrangement for Active Vibration Isolation Comprising an Inertial Reference Mass, assigned to the assignee of the present application and incorporated herein by reference. The reference mass provides a stationary point for measuring the distance to a payload, such as a photolithography table.

FIG. 1 is a block diagram of a standard suspension system. The standard model includes a mass M, which is to be isolated, supported above a surface with a stiffness k and a damping d. In vibration isolation applications, the stiffness k is small to provide a low resonance frequency. The stiffness k should be as small as possible to provide the best vibration isolation, but this results in poor performance when the mass M is excited by an external disturbance. First, such a system results in large temporal and spatial excursions when disturbed by an external force. Second, such a system exhibits slow settling behavior of the softly suspended mass after being disturbed by an external force. One approach to decrease the large excursions after an excessive disturbance occurs has been to incorporate a physical end stop to limit travel of the mass. This results in a relatively large disturbance force to the mass at the end stop and can result in an unpredictable settling time. In addition, alignment can be a problem if the free travel of the softly suspended mass is limited by the end stops.

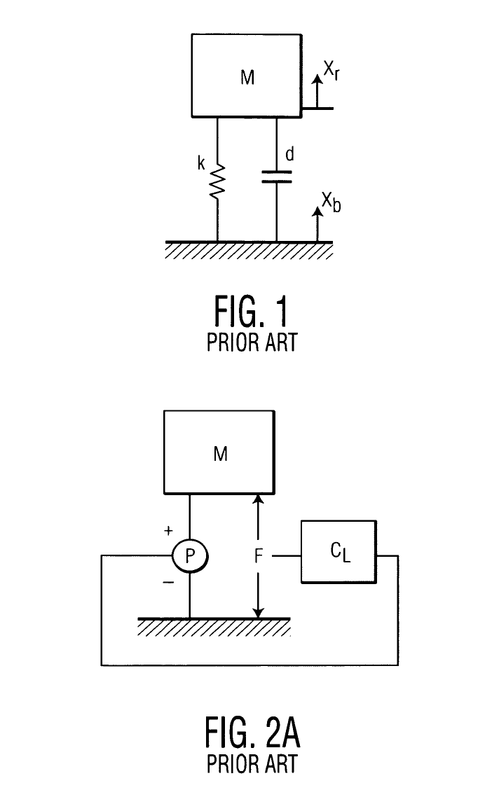

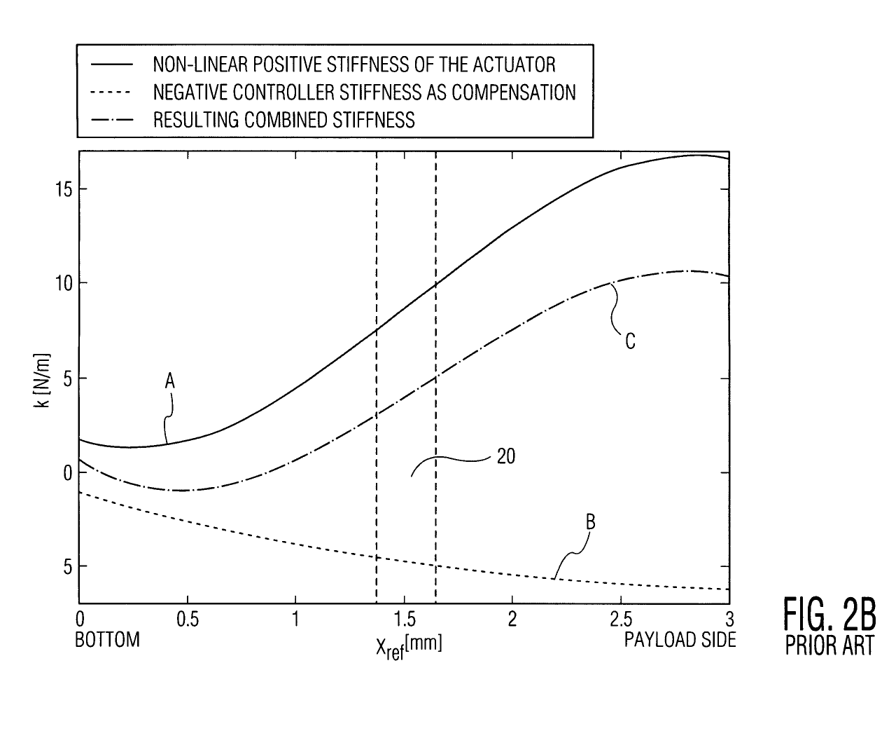

FIGS. 2A & 2B are a block diagram and a graph of stiffness k versus position x_{ref}, respectively, for an active suspension system. The active suspension system illustrated in FIG. 2A includes a mass M with position sensed by position sensor P. The position sensor P generates a position signal, which is provided to linear controller C_{L}. The linear controller C_{L} provides a linear control signal to an actuator F, which drives the mass M. The control loop provides the same stiffness and damping regardless of position error, resulting in the performance problems discussed above for FIG. 1.

FIG. 2B illustrates a stability problem arising in active suspension systems due to parasitic stiffness in real actuators when trying to suspend a mass at a very low frequency, such as 0.5 Hz. For a mass of 0.2 kg, the stiffness k of the active suspension system must be on the order of 2 N/m, which is very low. Unfortunately, the parasitic stiffness of real actuators is about 10 N/m, which is five to ten times the required stiffness of 2 N/m.

Referring to FIG. 2B, the operating range 20 for the reference mass is about 100 μm around a position x_{ref} of 1.5 mm. Curve A illustrates that the stiffness of the actuator F varies with position x_{ref}, i.e., the actuator stiffness is not constant with position. Curve B illustrates that the stiffness of the controller C_{L} varies with position x_{ref}, i.e., the controller stiffness is not constant with position. Curve C illustrates the combination stiffness resulting from combining the actuator stiffness of curve A and the controller stiffness of curve B.

The problem in this example occurs in the position x_{ref} between 0 and 1 mm, where the combination stiffness of curve C is negative. In this negative region, operation of the mass M is unstable. This would not be a problem if the negative region could be avoided, but the mass M must pass through the negative region as the system undocks at startup and the mass M moves to the operating range 20. The mass M can also enter the negative region due to excessive disturbances from floor vibrations and external forces acting on the mass. One approach to solve the stability problem is to add stiffness and/or damping to the controller stiffness of curve B, so the combination stiffness of curve C is no longer negative in the position x_{ref} between 0 and 1 mm. This creates additional problems, however, as the vibration isolation performance will degrade.

It would be desirable to have a vibration isolation system and method that overcomes the above disadvantages.

One aspect of the present invention provides a vibration isolation system for a mass including an actuator operably connected to the mass, the actuator being responsive to a combined control signal; a position sensor operably connected to measure position of the mass, the position sensor generating a position signal; a comparator responsive to the position signal and a position setpoint signal to generate a position error signal; and a combination controller responsive to the position error signal to generate the combined control signal; wherein the combination controller adjusts the combined control signal to change system characteristics when the position error signal is outside an operating range.

Another aspect of the present invention provides a vibration isolation method for a mass including measuring position of the mass; calculating position error from the position and a position setpoint; applying a first gain to control the mass when the position error is inside an operating range; and applying a second gain to control the mass when the position error is outside the operating range; wherein the second gain is greater than the first gain.

Another aspect of the present invention provides a vibration isolation system for a mass including means for measuring position of the mass; means for calculating position error from the position and a position setpoint; means for applying a first gain to control the mass when the position error is inside an operating range; and means for applying a second gain to control the mass when the position error is outside an operating range; wherein the second gain is greater than the first gain.

The foregoing and other features and advantages of the invention will become further apparent from the following detailed description of the presently preferred embodiment, read in conjunction with the accompanying drawings. The detailed description and drawings are merely illustrative of the invention rather than limiting, the scope of the invention being defined by the appended claims and equivalents thereof.

FIG. 1 is a block diagram of a standard suspension system;

FIGS. 2A & 2B are a block diagram and a graph of stiffness k versus position x_{ref}, respectively, for an active suspension system;

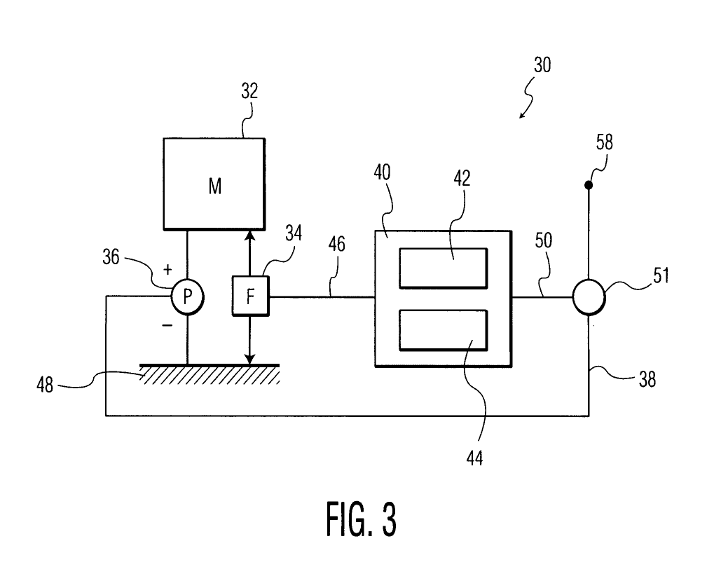

FIG. 3 is a block diagram of a vibration isolation system made in accordance with the present invention;

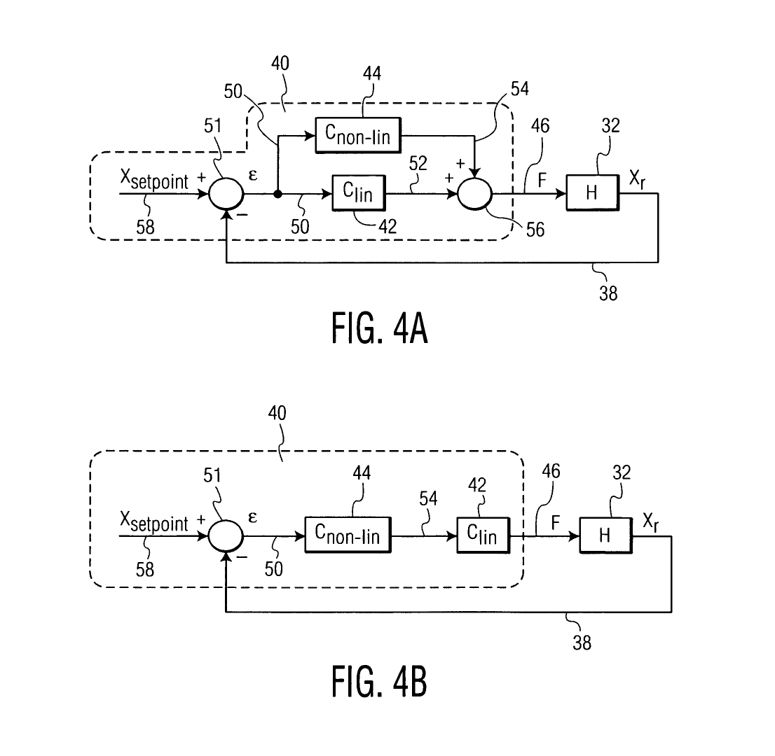

FIGS. 4A & 4B are block diagrams of parallel and series control structures of a vibration isolation system made in accordance with the present invention;

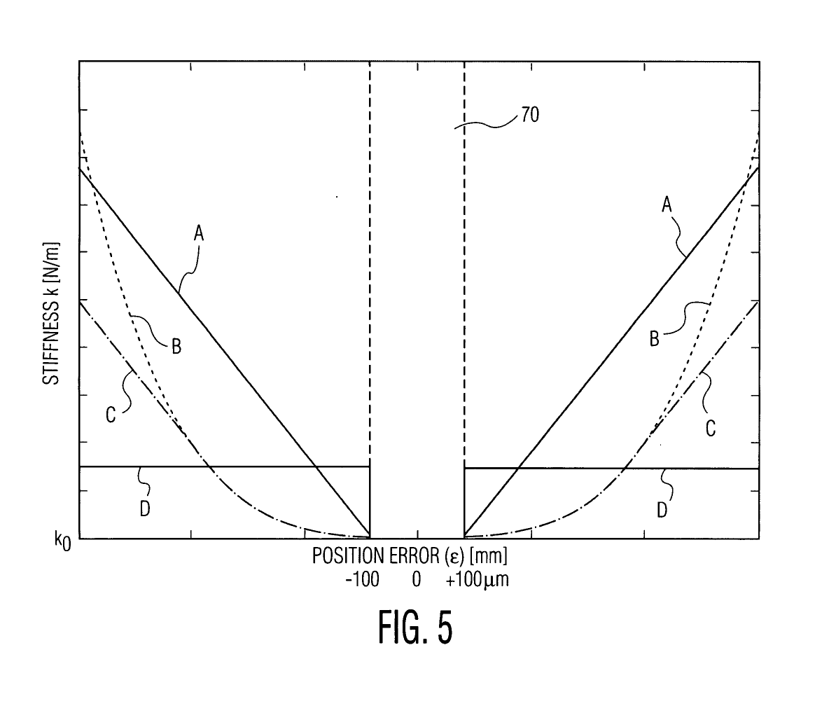

FIG. 5 is a graph of stiffness versus position error for a non-linear controller of a vibration isolation system made in accordance with the present invention;

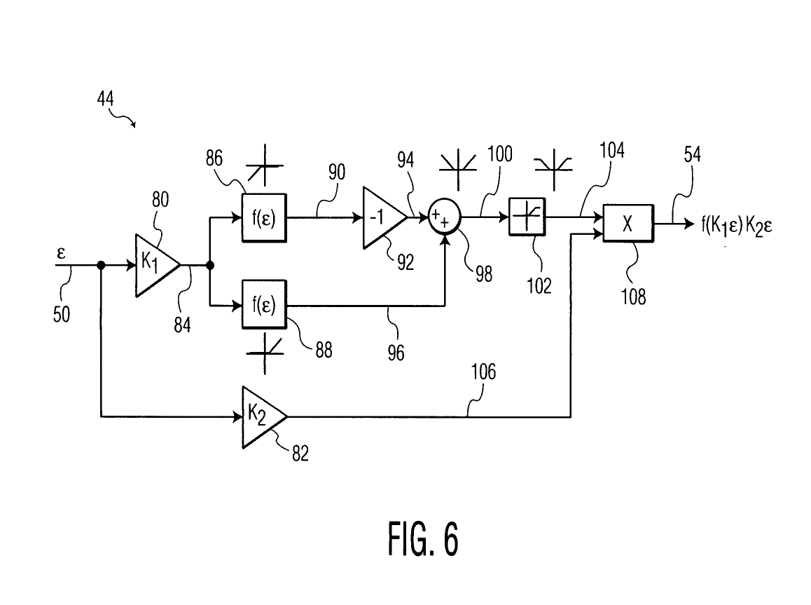

FIG. 6 is a block diagram of a non-linear controller of a vibration isolation system made in accordance with the present invention;

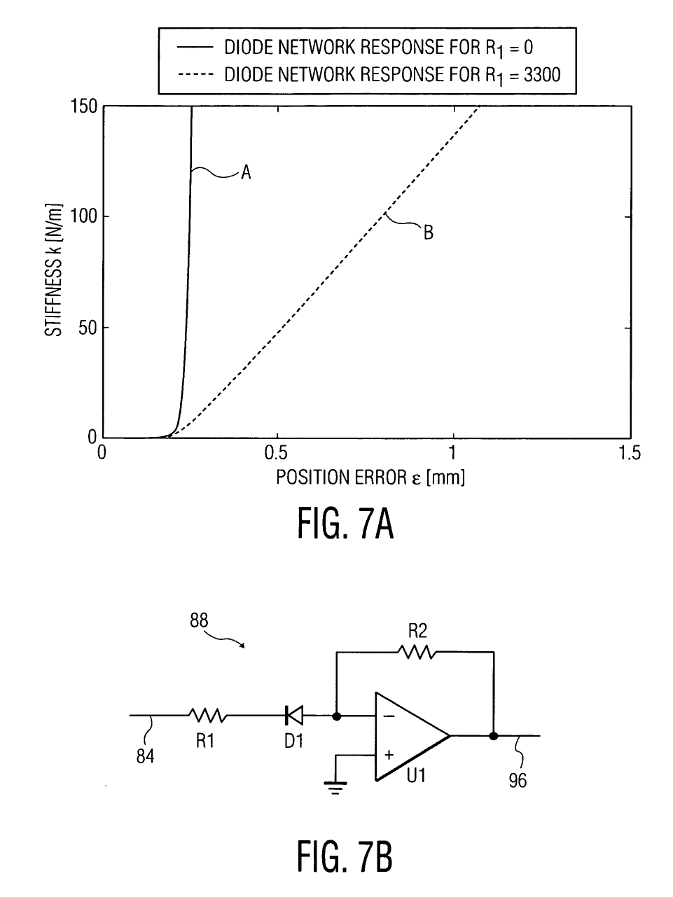

FIGS. 7A & 7B are a graph of stiffness versus position error and a schematic diagram, respectively, for a function generator of a vibration isolation system made in accordance with the present invention;

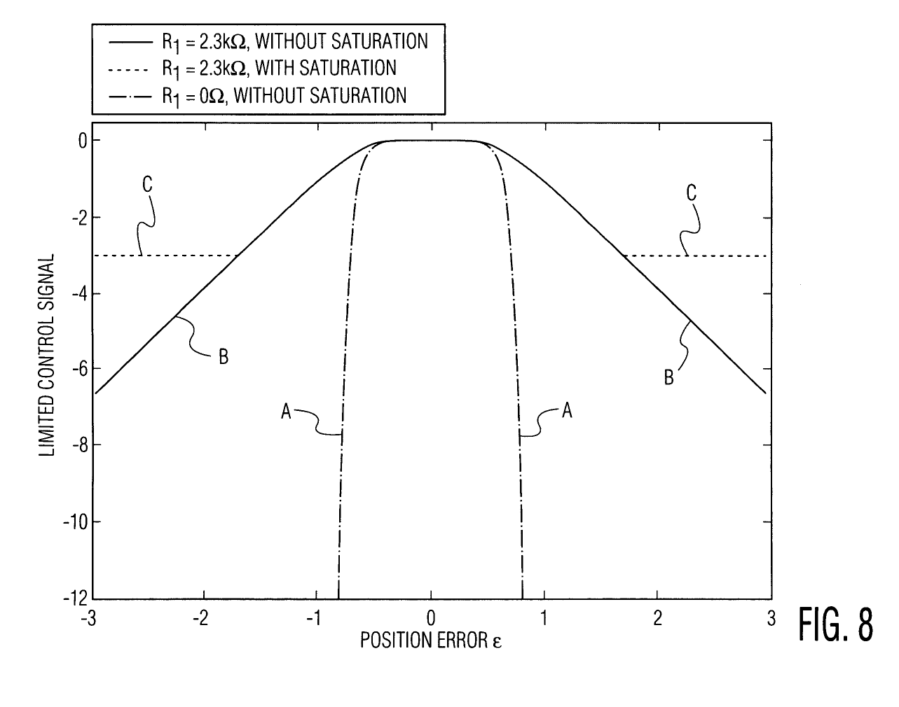

FIG. 8 is a graph of limited control signal versus position error for a vibration isolation system made in accordance with the present invention;

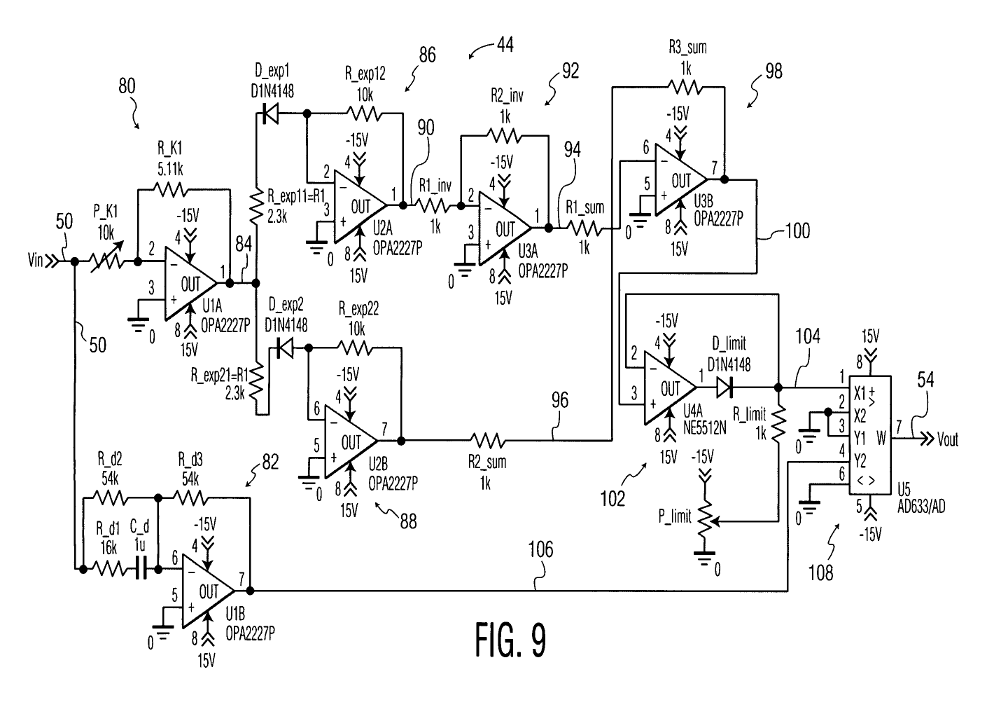

FIG. 9 is a schematic diagram of a non-linear controller of a vibration isolation system made in accordance with the present invention;

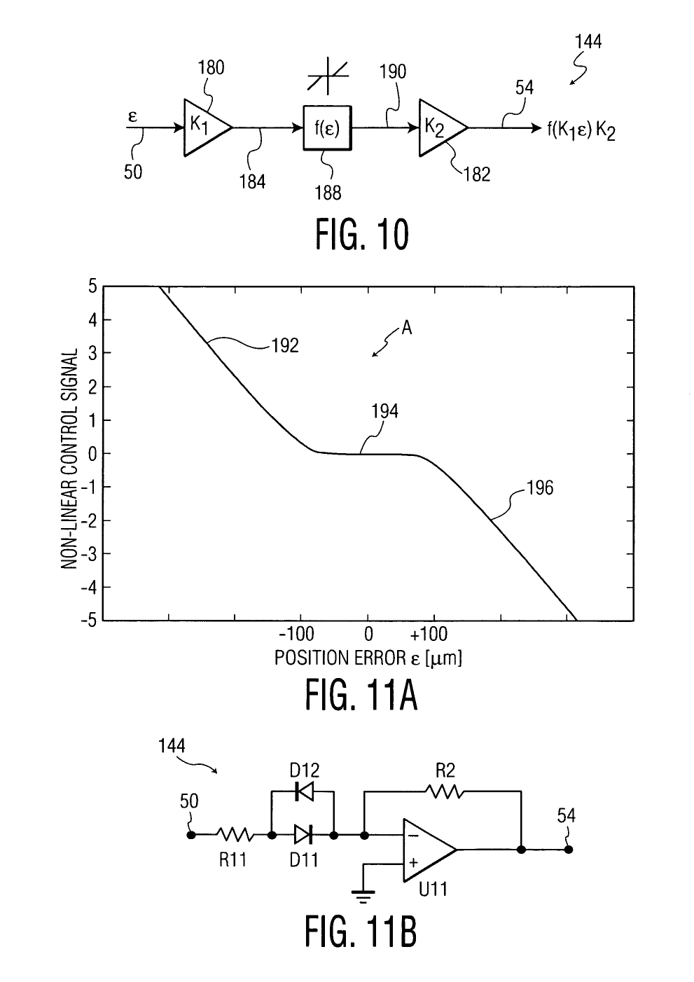

FIG. 10 is a block diagram of another embodiment of a non-linear controller of a vibration isolation system made in accordance with the present invention;

FIGS. 11A & 11B are a graph of the non-linear control signal versus position error and a schematic diagram, respectively, for another embodiment of a non-linear controller of a vibration isolation system made in accordance with the present invention; and

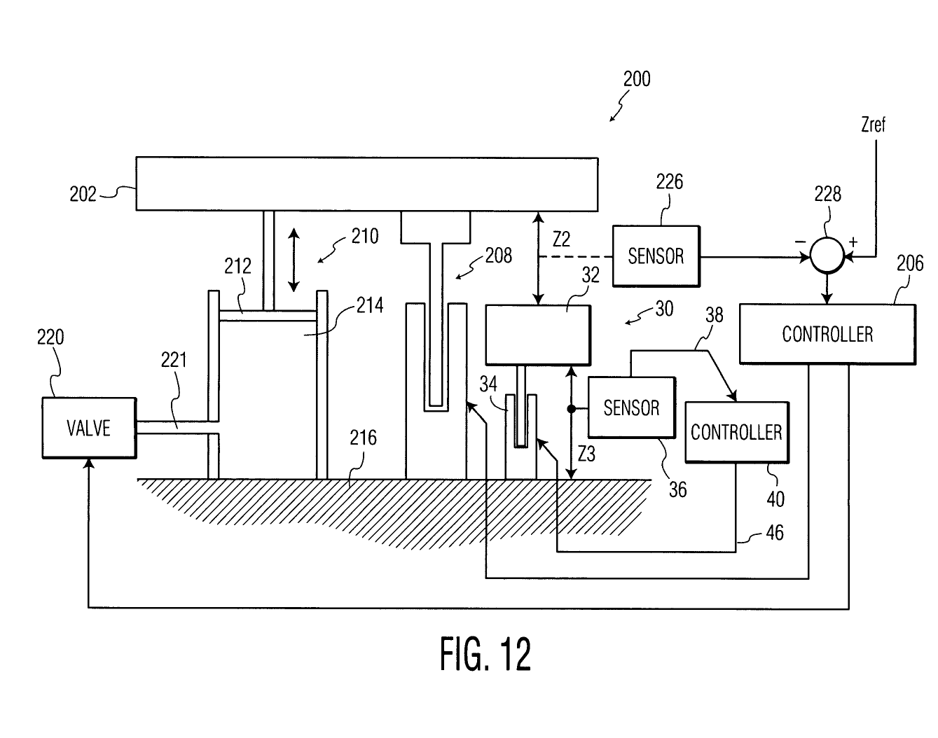

FIG. 12 is a block diagram of a payload isolation system for active vibration isolation employing a vibration isolation system made in accordance with the present invention.

FIG. 3 is a schematic diagram of a vibration isolation system made in accordance with the present invention. The vibration isolation system 30 for isolating a mass 32 includes an actuator 34, a position sensor 36, a comparator 51, and a combination controller 40. The position sensor 36 measures the position of the mass 32 and generates a position signal 38, which is provided to the comparator 51. The comparator 51 compares the position signal 38 to a position setpoint signal 58 and generates a position error signal 50. The combination controller 40 is responsive to the position error signal 50 to generate a combined control signal 46. The actuator 34 is responsive to the combined control signal 46 to drive the mass 32. In one embodiment, the combination controller 40 includes a linear controller 42 and a non-linear controller 44. In one embodiment, the comparator 51 is included in the combination controller 40. During operation, the mass 32 is normally positioned within a mass operating range. The non-linear controller 44 adjusts the combined control signal 46 to change system characteristics when the position signal 38 is outside an operating range corresponding to the mass operating range. As used herein, the system characteristics are defined as system stiffness and/or damping.

The mass 32 can be any mass for which isolation is desired. In one embodiment, the mass 32 is a photolithography table. In another embodiment, the mass 32 is the mass for a geophone. In yet another embodiment, the mass 32 is the reference mass in an payload isolation system for active vibration isolation comprising an inertial reference mass. The mass 32 can be suspended with more than one degree of freedom to account for movement in more than one direction. For example, the mass 32 can be mounted to allow horizontal or vertical motion.

The position sensor 36 can be any position sensor measuring the position of the mass 32 and generating a position signal 38 in response to the measurement. Examples of suitable position sensors include capacitive sensors, interferometers, inductive sensors, encoders, or the like. Those skilled in the art will appreciate that the position can be determined from other measurements, such as mass velocity or mass acceleration, as desired. In the example of FIG. 3, the position of the mass 32 is measured relative to a surface 48.

The combination controller 40 can be any non-linear controller responsive to the position error signal 50 to generate a combined control signal 46. The combination controller changes the system characteristics to provide progressive stiffness and/or damping. In one embodiment, the combination controller 40 has a linear controller 42 and a non-linear controller 44, the linear controller 42 providing a linear component to the combined control signal 46 and the non-linear controller 44 providing a non-linear component to the combined control signal 46. In one embodiment, the linear controller 42 is a PID (proportional, integral, derivative) controller. In an alternate embodiment, the combination controller 40 has a first and a second non-linear controller, the first non-linear controller providing a first non-linear component to the combined control signal 46 and the second non-linear controller 44 providing a second non-linear component to the combined control signal 46. In one embodiment, the combination controller 40 includes the comparator 51, so that the combination controller 40 is responsive to the position signal 38 and the position setpoint signal 58 to generate the position error signal 50. In one embodiment, the combination controller 40 can be implemented as one or more programs running on a computer, microcomputer, microprocessor, or the like. In another embodiment, the combination controller 40 can be implemented as a digital and/or analog circuit.

The actuator 34 can be any actuator operable to translate the mass 32. One example of the actuator 34 is a Lorentz motor. In one embodiment, the output force of the actuator 34 is proportional to the input current of the combined control signal 46. In one embodiment, the actuator 34 is a linear drive. In another embodiment, the actuator 34 is a rotary drive with appropriate gearing to translate the rotary motion to linear motion. Those skilled in the art will appreciate that the actuator 34 typically includes an amplifier, such as a current or voltage amplifier, to boost the combined control signal 46 to a desired level for operating the actuator.

In operation, the position sensor 36 measures the position of the mass 32 and provides a position signal 38 indicative of the position to the comparator 51, which calculates a position error signal 50 from the position signal 38 and a position setpoint signal 58. In response to the position error signal 50, the combination controller 40 provides a combined control signal 46 to the actuator 34 to adjust the position of the mass 32. When the position error signal 50 is inside the operating range, the combination controller 40 has a first gain to control the mass 32, i.e., to control the force applied to the mass 32 by the actuator 34. When the position error signal 50 is outside the operating range, the combination controller 40 has a second gain to control the mass 32, i.e., to control the force applied to the mass 32 by the actuator 34. The second gain is greater than the first gain.

FIGS. 4A & 4B are block diagrams of parallel and series control structures of a vibration isolation system made in accordance with the present invention. A non-linear controller in the combination controller changes system characteristics of the vibration isolation system when the position error is outside its operating range, adding extra stiffness and/or damping to the stiffness and/or damping provided by the linear controller.

FIG. 4A illustrates a parallel control structure. At comparator 51, a position setpoint signal 58 (xₛₑₜₚₒᵢₙₜ) is compared to the position signal 38 (xᵣ), which indicates position of the mass 32, to generate a position error signal 50 (ε). The position error signal 50 is provided to the linear controller 42 and the non-linear controller 44 of the combination controller 40. The linear controller 42 is responsive to the position error signal 50 to generate a linear control signal 52. The non-linear controller 44 is responsive to the position error signal 50 to generate a non-linear control signal 54. The linear control signal 52 and the non-linear control signal 54 are summed at summing node 56 to generate the combined control signal 46. The actuator (not shown) applies a force F to the mass 32 in response to the combined control signal 46. The non-linear control signal 54 contributes to the combined control signal 46 when the position error signal 50 indicates that the mass 32 is outside its operating range, i.e., when the absolute value of the position error signal 50 exceeds a predetermined value.

FIG. 4B illustrates a series control structure. At comparator 51, a position setpoint signal 58 (xₛₑₜₚₒᵢₙₜ) is compared to the position signal 38 (xᵣ), which indicates position of the mass 32, to generate a position error signal 50 (ε). The position error signal 50 is provided to the non-linear controller 44 of the combination controller 40. The non-linear controller 44 is responsive to the position error signal 50 to generate a non-linear control signal 54, which is provided to the linear controller 42. The linear controller 42 is responsive to the non-linear control signal 54 to generate the combined control signal 46. The actuator (not shown) applies a force F to the mass 32 in response to the combined control signal 46. The non-linear controller 44 contributes a non-linear component to the combined control signal 46 when the position error signal 50 indicates that the mass 32 is outside its operating range. The linear controller 42 modifies the non-linear control signal 54 and contributes a linear component to the combined control signal 46. Those skilled in the art will appreciate that the order of the linear controller 42 and the non-linear controller 44 can be switched as desired.

FIG. 5 is a graph of stiffness versus position error for a non-linear controller of a vibration isolation system made in accordance with the present invention. The stiffness from the non-linear controller is in addition to the stiffness provided by the linear controller. In this example, the control structure is a parallel control structure, with the non-linear controller being responsive to a position error signal and generating a non-linear control signal. Each curve includes an operating range portion applied when the position error is within its operating range and a progressive stiffness portion applied when the position error is outside its operating range. The stiffness is a base stiffness in the operating range portion and an increased stiffness in the progressive stiffness portion. The stiffness is indicative of the gain of the non-linear controller.

Curves A-D of FIG. 5 illustrate various embodiments of non-linear controller curves. Each curve has an operating range portion with a base stiffness k₀ in the operating range 70, which in this example corresponds to a position error of 0±100 μm, and progressive stiffness portions outside the operating range 70. In one embodiment, the base stiffness k₀ is minimal or zero. In another embodiment, the base stiffness k₀ is a predetermined stiffness value to produce a desired resonance frequency in the vibration isolation system. In one example, a small base stiffness k₀ of 2 N/m is used to create a 0.5 Hz resonance frequency for a soft suspended reference mass. Those skilled in the art will appreciate that the linear controller can be omitted as desired when the non-linear controller provides the required base stiffness in the operating range portion.

Curves A-D of FIG. 5 also illustrate examples of different progressive stiffness portions. Curve A has a sloped linear progressive stiffness portion, with the stiffness increasing linearly with the distance from the operating range. Curve B has a parabolic progressive stiffness portion, with the stiffness increasing parabolically with the distance from the operating range. Curve C has a hybrid progressive stiffness portion, with the stiffness of the progressive stiffness portion initially increasing parabolically with the distance from the operating range in a smooth transition portion, and then increasing linearly in a linear portion. Curve D has a stepped progressive stiffness portion, with the stiffness of the progressive stiffness portion being constant for all position errors. Those skilled in the art will appreciate that the shape of the progressive stiffness portion can be any shape which is desirable for the system dynamics of a particular system. For example, the shape of the progressive stiffness portion can be stepped, sloped linear, parabolic, hyperbolic, another conic section, combinations thereof, or the like. In one embodiment, the progressive stiffness portion of the non-linear controller curve can be clipped at a predetermined maximum stiffness so the value of the progressive stiffness portion is limited when the absolute value of the position error becomes large, i.e., when the position error is outside a predetermined range. In one embodiment, the non-linear controller curve makes a smooth transition between the operating range portion and the progressive stiffness portion to avoid undesirable system excitation due to transition effects as the system passes in and out of the operating range. Both Curves B and C illustrate smooth transitions.

FIG. 6 is a block diagram of a non-linear controller of a vibration isolation system made in accordance with the present invention. The non-linear controller is responsive to the position error signal and generates the non-linear control signal. The small graphs adjacent the elements and signals indicate the signal at that point as a function of the position error signal.

In this example, the non-linear controller 44 receives the position error signal 50 (ε), which is provided to first gain element 80 and second gain element 82. The first gain element 80 generates a first scaled position error signal 84, which is provided to first function generator 86 and second function generator 88. The first function generator 86 generates negative input control signal 90, which inverter 92 converts to an inverted negative input control signal 94. The second function generator 88 generates positive input control signal 96, which is summed with inverted negative input control signal 94 at summing node 98 to generate positive control signal 100. In one embodiment, the positive control signal 100 is clipped at optional limiter 102 to generate limited control signal 104. The limiter 102 can be used to clip the limited control signal 104, i.e., to limit the magnitude of the limited control signal 104 when the position error is outside a predetermined range. This is desirable in some vibration isolation systems to limit stiffness and avoid potential instability and oscillations when the vibration isolation system encounters a large position excursion. In another embodiment, the limiter 102 is omitted and the positive control signal 100 provided directly to the multiplier 108. The second gain element 82 is responsive to the position error signal 50 to generate a second scaled position error signal 106, which is provided to the multiplier 108. The multiplier 108 multiplies the limited control signal 104 and the second scaled position error signal 106 to generate the non-linear control signal 54.

The elements and values of the non-linear controller 44 can be varied for the desired performance. The gain K₁ of the first gain element 80 can be selected to adjust the overall range of the non-linear controller 44 by scaling the position error signal 50. The gain K₂ of the second gain element 82 can be selected to adjust the overall gain of the non-linear controller 44. In another embodiment, the second gain element 82, which is a proportional controller in the example of FIG. 6, can be replaced with a proportional-derivative (PD) controller to increase the damping constant of the vibration isolation system outside the operating range. In one embodiment, the first function generator 86 and second function generator 88 can be diode-resistor circuits, with the value of the first resistor determining the gain of the progressive stiffness portion of the non-linear controller curve. Those skilled in the art will appreciate that the function generators can be any analog and/or digital circuits providing zero or minimal stiffness in the operating range and increasing stiffness with the distance from the operating range. The first function generator 86 and second function generator 88 can be the same or can be different. The stiffness can be symmetric or asymmetric about the center (zero position error) of the operating range.

FIGS. 7A & 7B are a graph of stiffness versus position error and a schematic diagram, respectively, for a function generator of a vibration isolation system made in accordance with the present invention. The second function generator 88 is a diode-resistor circuit including first resistor R1 receiving the first scaled position error signal 84, diode D1, second resistor R2, and operational amplifier U1 providing the positive input control signal 96. The graph of stiffness versus position error of FIG. 7A illustrates how the gain of the progressive stiffness portion of the non-linear controller curve can be determined by the resistance of the first resistor R1. The stiffness is indicative of the gain of the non-linear controller. The second function generator 88 provides a non-linear controller curve which is approximately zero for negative position errors and has positive values and a positive slope for positive position errors in the progressive stiffness portion. Curve A for a first resistor resistance of zero ohms has an exponential gain in the progressive stiffness portion. Curve B for a first resistor resistance of 3300 ohms has a constant gain of about −R2/R1 in the progressive stiffness portion, and resembles a standard inverting amplifier. The resistance values of the first resistor R1 and second resistor R2 can be selected to provide the gain desired for the particular vibration isolation system. Those skilled in the art will appreciate that the diode direction (the bias direction) of the diode D1 can be reversed to build the first function generator 86 of FIG. 6, i.e., to provide a non-linear controller curve which is approximately zero for positive position errors and has negative values and a positive slope for negative position errors in the progressive stiffness portion.

FIG. 8 is a graph of limited control signal versus position error for a vibration isolation system made in accordance with the present invention. FIG. 8 provides measured values of the limited control signal 104 as a function of the position error signal 50 for the non-linear controller 44 of FIG. 6, with the limited control signal 104 inverted. In this example, the first function generator 86 and second function generator 88 are diode-resistor circuits as discussed for FIGS. 7A & 7B. In Curve A of FIG. 8, the first resistor R1 has resistance of zero ohms and no limiter 102 is used, resulting in an exponential gain in the progressive stiffness portions. In Curve B, the first resistor R1 has resistance of 2.3 kOhms and no limiter 102 is used, resulting in near linear gain in the progressive stiffness portions without clipping, i.e., the magnitude of the limited control signal is not limited. In Curve C, the first resistor R1 has resistance of 2.3 kOhms and a limiter 102 is used, resulting in linear gain in the progressive stiffness portions with clipping.

FIG. 9, in which like elements share like reference numbers with FIG. 6, is a schematic diagram of the non-linear controller of a vibration isolation system made in accordance with the present invention. In this example, the first function generator 86 and second function generator 88 are diode-resistor circuits.

FIG. 10 is a block diagram of another embodiment of a non-linear controller of a vibration isolation system made in accordance with the present invention. The non-linear controller is responsive to the position error signal and generates the non-linear control signal. The non-linear control signal can be combined with the linear control signal from the linear controller to generate the combined control signal.

In this example, the non-linear controller 144 receives the position error signal 50 (ε), which is provided to first gain element 180. The first gain element 180 generates a scaled position error signal 184, which is provided to function generator 186. The function generator 186 generates input control signal 190, which is provided to second gain element 182. The small graph adjacent the function generator 186 indicates the signal at that point as a function of the scaled position error signal 184. The second gain element 182 generates the non-linear control signal 54.

In another embodiment, the non-linear controller 144 can include a limiter to clip the non-linear control signal 54, i.e., to limit the magnitude of the non-linear control signal 54 when the position error is outside a predetermined range. The gain K₁ of the first gain element 180 can be selected to adjust the overall range of the non-linear controller 144 by scaling the position error signal 50. The gain K₂ of the second gain element 182 can be selected to adjust the overall gain of the non-linear controller 144.

FIGS. 11A & 11B are a graph of the non-linear control signal versus position error and a schematic diagram, respectively, for another embodiment of a non-linear controller of a vibration isolation system made in accordance with the present invention. In this example, the non-linear controller 144 is a double diode-resistor circuit including first resistor R11, first diode D11, second diode D12, second resistor R12, and operational amplifier U11. The first diode D11 and second diode D12 are mounted in a double diode configuration, with the cathode of each diode connected to the diode of the other diode. This provides the operating range portion of the non-linear controller curve: neither the first diode D11 nor the second diode D12 conduct until the absolute value of the position error signal 50 provides sufficient forward bias voltage. The gain of the progressive stiffness portion of the non-linear controller curve can be determined by the resistance of the first resistor R11. The non-linear controller curve A has a first progressive stiffness portion 192, an operating portion 194, and a second progressive stiffness portion 196. Curve A has a constant gain of about −R12/R11 in the progressive stiffness portions. Those skilled in the art will appreciate that the non-linear controller curve A can be adapted further as desired for a particular use.

FIG. 12 is a block diagram of a payload isolation system for active vibration isolation employing a vibration isolation system made in accordance with the present invention. The vibration isolation system provides a stationary reference mass. A payload isolation system 200 for isolating a payload 202 includes an actuator 208, an airmount 210, mass 32, and vibration isolation system 30. In one example, the payload 202 is a metroframe in a lithography machine. The actuator 208, such as a Lorentz motor, can be disposed between the payload 202 and earth 216. The airmount 210 includes a piston 212 and a gas-filled housing 214 in which the piston 212 can move. A valve 220 is connected to the housing 214 by channel 221.

The vibration isolation system 30 for isolating the mass 32, which is a stationary reference mass soft suspended for the payload isolation system 200, includes an actuator 34 driving the mass 32, and a position sensor 36 measuring the position of the mass 32. The position sensor 36 measures the distance Z3 between the mass 32 and earth 216, and generates a position signal 38, which is provided to a combination controller 40. The combination controller 40 is responsive to the position signal 38 to generate a combined control signal 46. The actuator 34 is responsive to the combined control signal 46 to drive the mass 32. In one embodiment, the combination controller 40 includes a linear controller and a non-linear controller. During operation, the mass 32 is normally positioned within a mass operating range. The non-linear controller 44 adjusts the combined control signal 46 to change system characteristics when the position signal 38 is outside an operating range corresponding to the mass operating range. As used herein, the system characteristics are defined as system stiffness and/or damping. Those skilled in the art will appreciate that the combination controller 40 can be any non-linear controller responsive to the position error signal 50 to generate a combined control signal 46 and change the system characteristics.

A sensor 226 measures the distance Z2 between the reference mass 32 and the payload 202. The sensor 226 sends an output signal to comparator 228. The comparator 228 also receives a reference signal Zref and subtracts the output signal received from the sensor 226 from Zref. An output signal based on this comparison is applied by the comparator 228 to the controller 206. The controller 206 is connected to the actuator 208 and can be connected to the valve 220. Those skilled in the art will appreciate that the controller 206 can be a non-linear combination controller changing the system characteristics to provide progressive stiffness and/or damping. In one embodiment, the controller 206 includes a linear controller and a non-linear controller.

While the embodiments of the invention disclosed herein are presently considered to be preferred, various changes and modifications can be made without departing from the scope of the invention. In one example, the electronics generating and processing the various signals discussed herein can be analog circuits, digital circuits, or a combination of analog and digital circuits. In another example, the control loops described herein can also include filters, such as low pass filters, general second order filters, and/or notch filters. One illustration of the use of filters is using a filter to adjust system dynamics, such as using a filter to notch away a mechanical resonance causing system instability. Another illustration of the use of filters is using a low pass filter to reduce the influence of sensor noise. The scope of the invention is indicated in the appended claims, and all changes that come within the meaning and range of equivalents are intended to be embraced therein.

1. A system for isolating a mass from vibration comprising:
an actuator 34 operably connected to the mass 32, the actuator 34 being responsive to a combined control signal 46;
a position sensor 36 operably connected to measure position of the mass 32, the position sensor 36 generating a position signal 38;
a comparator 51 responsive to the position signal 38 and a position setpoint signal 58 to generate a position error signal 50; and
a combination controller 40 responsive to the position error signal 50 to generate the combined control signal 46;
wherein the combination controller 40 adjusts the combined control signal 46 to change system characteristics when the position error signal 50 is outside an operating range.

2. The system of claim 1 wherein the actuator 34 is a Lorentz motor.

3. The system of claim 1 wherein the combination controller 40 comprises a linear controller 42 and a non-linear controller 44, the linear controller 42 providing a linear component to the combined control signal 46 and the non-linear controller 44 providing a non-linear component to the combined control signal 46.

4. The system of claim 3 wherein linear controller 42 and a non-linear controller 44 are connected in a control structure selected from the group consisting of a series control structure and a parallel control structure.

5. The system of claim 3 wherein the non-linear component has a progressive stiffness portion outside the operating range.

6. The system of claim 3 wherein the non-linear component has an operating range portion inside the operating range with a base stiffness selected from the group consisting of zero stiffness, minimal stiffness, and predetermined stiffness.

7. The system of claim 5 wherein the shape of the progressive stiffness portion is selected from the group consisting of stepped, sloped linear, parabolic, hyperbolic, conic sections, and combinations thereof.

8. The system of claim 5 wherein the progressive stiffness portion has a smooth transition portion.

9. The system of claim 1 wherein the operating range is plus or minus 100 μm about a zero position error.

10. The system of claim 3 further comprising a summing node 56 responsive to a linear control signal 52 and a non-linear control signal 54 to generate the combined control signal 46;
wherein the non-linear controller 44 comprises:
a first gain element 80 responsive to the position error signal 50 to generate a first scaled position error signal 84;
a first function generator 86 responsive to the first scaled position error signal 84 to generate a negative input control signal 90;
an inverter 92 responsive to the negative input control signal 90 to generate an inverted negative input control signal 94;
a second function generator 88 responsive to the first scaled position error signal 84 to generate a positive input control signal 96;
a summing node 98 responsive to the inverted negative input control signal 94 and the positive input control signal 96 to generate a positive control signal 100;
a second gain element 82 responsive to the position error signal 50 to generate the second scaled position error signal 106;
a multiplier 108 responsive to the positive control signal 100 and the second scaled position error signal 106 to generate the non-linear control signal 54.

11. The system of claim 10 further comprising a limiter 102 responsive to the positive control signal 100 to generate a limited control signal 104, the limited control signal 104 being provided to the multiplier 108 as the positive control signal 100.

12. The system of claim 10 wherein at least one of the first function generator 86 and the second function generator 88 is a diode-resistor circuit.

13. The system of claim 10 wherein the second gain element 82 is a proportional-derivative (PD) controller.

14. The system of claim 3 further comprising a summing node 56 responsive to a linear control signal 52 and a non-linear control signal 54 to generate the combined control signal 46;
wherein the non-linear controller 44 comprises:
a first gain element 180 responsive to the position error signal 50 to generate a scaled position error signal 184;
a function generator 186 responsive to the scaled position error signal 184 to generate a input control signal 190; and
a second gain element 182 responsive to the input control signal 190 to generate the non-linear control signal 54.

15. The system of claim 14 further comprising a limiter 102 responsive to the non-linear control signal 54 to limit the non-linear control signal 54.

16. The system of claim 14 wherein the function generator 186 is a double diode-resistor circuit.

17. The system of claim 1 wherein the mass 32 is a reference mass in an payload isolation system for active vibration isolation.

18. A method for isolating a mass from vibration comprising:
measuring position of the mass;
calculating position error from the position and a position setpoint;
applying a first gain to control the mass when the position error is inside an operating range; and
applying a second gain to control the mass when the position error is outside the operating range;
wherein the second gain is greater than the first gain.

19. The method of claim 18 further comprising limiting the second gain when the position error is outside a predetermined range.

20. The method of claim 18 wherein the second gain increases with absolute value of the position error.

21. A system for isolating a mass from vibration comprising:
means for measuring position of the mass;
means for calculating position error from the position and a position setpoint;
means for applying a first gain to control the mass when the position error is inside an operating range; and
means for applying a second gain to control the mass when the position error is outside an operating range;
wherein the second gain is greater than the first gain.

22. The method of claim 21 further comprising means for limiting the second gain when the position error is outside a predetermined range.

23. The method of claim 21 wherein the second gain increases with absolute value of the position error.

24. The method of claim 23 wherein the second gain increases according to a function selected from the group consisting of stepped, sloped linear, parabolic, hyperbolic, conic sections, and combinations thereof.
